(19) United States
(12) Patent Application Publication
(10) Pub. No.: US 2009/0292965 A1
(43) Pub. Date: Nov. 26, 2009

(54) METHOD FOR TRANSMITTING WIRELESS DATA AND RECORDING MEDIUM STORING PROGRAM FOR EXECUTING THE METHOD

(76) Inventors: Soo-Hyun Park, Seoul (KR); Soo-Young Shin, Seoul (KR); Yoo-Jin Jung, Seoul (KR)

Correspondence Address: BRINKS HOFER GILSON & LIONE, P.O. BOX 10395, CHICAGO, IL, 60610, US

(21) Appl. No.: 12/373,851

(22) PCT Filed: May 31, 2007
(86) PCT No.: PCT/KR2007/002645

§ 371 Date: Apr. 2, 2009

(30) Foreign Application Priority Data
Jul. 14, 2006 (KR) 10-2006-0066589

(51) Int. Cl. H04L 1/14

(52) U.S. Cl. 714/750

(57) ABSTRACT

A method of transmitting wireless data and a recorded medium storing a computer program therefor. The method of transmitting data by a sender coupled to a receiver through a network can include transmitting a data frame having an Initiation field to the sender and transmitting a plurality of data frames corresponding to the Initiation field. The present invention can improve the completion rate of data transmission under an extremely-poor wireless environment.

### TECHNICAL FIELD

The present invention relates to a wireless data transmission method, more particularly, a method for efficiently transmitting data under an extremely-poor telecommunication environment.

### BACKGROUND ART

With the advancement of the wireless telecommunication technologies, there are increased possibilities of telecommunication in new domains. Namely, the wireless telecommunication may be needed in various and extremely-poor environments (for example, the North Pole or South Pole), and may be performed under the bad weather like hurricane or in the deep sea. In instances where the data transmission quality may be varied due to the types of media, and the medium access technology will be changed to be suitable to the data transmission environment.

Recently, it is noticeable that researches on the underwater telecommunication have started globally. In instances where the wireless telecommunication is performed underwater, sound wave signals are generally used. It is because the sound wave signal propagates fast in the water than in air and with ranges over several kilometers. However, the wireless telecommunication is affected mostly by the surrounding, for example, the season and the depth of water. Accordingly, problems occurred by the environments should be considered for the underwater wireless telecommunication. As the physical link of poor quality with limited bandwidth is provided in an underwater environment, there are high rates of error and delay in underwater wireless telecommunication. Also, the underwater wireless telecommunication may have unpredictable state changes of channel due to each environmental variable, and have distortion due to the Doppler Effect. Especially, there are serious reflections and diffusions in the surface and bottom of a shallow sea, and the characteristics of the medium are different due to the fresh water, thereby increasing the probability of erroneous detection.

Until now, the underwater telecommunication has not been widely used as compared to the ground wireless telecommunication. Nevertheless, the underwater wireless telecommunication can be applied to various fields (e.g., collecting oceanic data, detecting a pollution level, oceanographic exploration, disaster prevention, providing navigation information, tactical detection, etc.), and improving the completion rate of underwater data transmission and detecting/recovering data transmission error with minimum cost are very important.

FIG. 1 shows a basic mechanism of S&W (Stop-and-Wait) ARQ, and FIG. 2 shows ACK mechanism in Normal ARQ.

Referring to FIG. 1, ARQ (Automatic Repeat Request) mechanism is usually used in the retransmission of packets having an error. The retransmission of packets having an error may be repeated several times till the packet is transmitted successfully. In the S&W (Stop-and-Wait) ARQ, which is the most basic mechanism of ARQ, in FIG. 1, a sender after transmission of the packet waits until receiving a response (“ACK”) from a receiver.

Also, as shown in FIG. 2, the receiver notifies the success/failure of packet by sending ACK for each packet. If ACK does not arrive until a time-out or NAK (Negative ACK) arrives, then the sender retransmits the packet; if ACK arrives, then the sender transmits the next packet.

S&W ARQ mechanism has advantages in that the telecommunication protocol is simple and the credibility of data transmission is high. Yet, the transmission delay rate increases along with the increase of packet size, and consequently the link efficiency decreases. Also, the sender cannot transmit the next data frame until receiving ACK/NAK from the receiver or a time-out (the maximum time to wait for a response from the receiver after data transmission) occurs so that the data cannot be transmitted successively.

To reduce the waste of channels, the block ACK (“BA”) mechanism, which is an adaptive acknowledge mechanism based on the IEEE 802.11e standard, can be applied. Hereinafter, the BA mechanism will be discussed with reference to FIG. 3 to FIG. 5.

FIG. 3 shows a basic procedure of the BA mechanism based on IEEE 802.11e, and FIG. 4 shows the basic frame configuration of enhanced BA based on IEEE 802.11n.

Referring to FIG. 4, MPDUs (MAC Protocol Data Units) are transmitted in units of blocks, which are divided into SIFS (Short Inter Frame Space) periods. The sender does not transmit a response for each block, but the sender transmits an aggregating ACK, namely BA, to the sender after receiving the last block.

Two BAs are used in the 802.11e standard, one an immediate Block Ack (FIG. 3(a)), which is for a high-bandwidth and low latency traffic, and the other a delayed Block Ack (FIG. 3(b)), which is less sensitive to the delay.

Since the Block Ack mechanism in the IEEE 802.11e standard is designed for 802.11 series with a sufficient bandwidth, there are many control packets during the setup and sequencing procedures for exchanging BA, when it is used for telecommunication under an extremely-poor environment (e.g., underwater), and thus an excessive overload may occur. In addition, even though the immediate Block Ack might be applied to the Block Ack mechanism, it is impossible to practically use due to the high delay rate of immediate Black Ack.

It is expected that IEEE 802.11n under discussion for standardization may use the Enhanced BA mechanism that has an enhanced function of Block Ack in IEEE 802.11e, and the basic frame configuration is shown in FIG. 4.

Referring to FIG. 4, Compressed BA to be used in IEEE 802.11n is defined as a compressed-transformed MPDU format used in IEEE 802.11e. IEEE 802.11n reduces complexity on the receiver side by using a frame structure whose partial shape is based on the Immediate Block Ack of IEEE 802.11e, and uses No Ack for the application of Delayed Block Ack. Using the Enhanced Block Ack method may increase the efficiency in the network than using the BA method of IEEE 802.11e but reduces the reliability of data transmission due to the absence of ACK following data transmission.

### DISCLOSURE

### Technical Problem

The present invention provides a wireless data transmission method and recording medium storing program thereof for improving success rate of data transmission under an extremely-poor environment.

The present invention also provides a wireless data transmission method and recording medium storing program thereof for improving the efficiency of a network by reducing the number of data transmission.

Other problems that the present invention solves will be easily understood through the embodiments described hereinafter.

### Technical Solution

To solve the problems described above, an aspect of the present invention feature a method of transmitting data by a sender coupled to a receiver through a network. The method includes transmitting a data frame having an Initiation field to the sender and transmitting a plurality of data frames corresponding to the Initiation field.

The method can also include receiving an ACK corresponding to transmission of the data frame having the Initiation field from the receiver. When receiving the ACK, the plurality of data frames is transmitted to the receiver.

One of the plurality of data frames can include a block ACK request field.

The Initiation field and block ACK request field can have a flag field and a state field.

The method can also include receiving a Block ACK from the receiver, which can include a Block Packing field.

The method can also include determining whether the received Block ACK is a PBA or a PB-NAK and transmitting to the receiver the data frame that is not included in the Block Packing field if the received Block ACK is a PBA.

The method can also include transmitting to the receiver the data frame that is included in the Block Packing field if the received Block ACK is a PB-NAK.

The method can also include determining during data frame transmission whether or not the data frame stored in the sender is larger than a predetermined minimum size. The transmitting data frame having the Initiation field can be performed if the data frame size is larger than the predetermined minimum size.

The method can also include dividing data frame by use of a predetermined function if the data frame stored in the sender is larger than a predetermined maximum size.

Another aspect of the present invention features a method of processing data by a receiver coupled to a sender through a network. The method can include receiving a data frame having an Initiation field from the sender and storing a plurality of data frames corresponding to the Initiation field received from the sender.

The method can also include storing information on whether or not each of the plurality of data frames is successfully transmitted.

The method can also include setting a queue of the receiver to a size corresponding to the Initiation field.

The method can also include transmitting to the sender an ACK corresponding to the receiving of the data frame having the Initiation field.

The method can also include determining whether or not a data frame having a Block ACK request field is received when receiving the plurality of data frames, comparing the number of data frames that are successfully transmitted and the number of data frames that failed transmission if the plurality of data frames having Block ACK request field are received and transmitting the PBA in the Block ACT to the sender if the number of data frames that failed transmission is equal to or greater than the number of data frames that are successfully transmitted.

The method can also include transmitting a PB-NAK to the sender if the number of data frames that are successfully transmitted is greater than the number of data frames that failed transmission.

The Block ACK can include a flag field and a Block Packing field.

The method can also include receiving from the sender the data frame corresponding to the PBA or PB-NAK transmitted to the sender, sorting the received data frame in order by synchronizing with the data frame that failed transmission, and forwarding the sorted data frame set to a higher layer.

Another aspect of the present invention can feature a recorded medium, which can tangibly embody a program of instructions executable by a digital processing device for performing the method of transmitting or processing data of any of Claims 1 through 17. The recorded medium can be by the digital processing device.

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, some embodiments will be described in detail with reference to the accompanying drawings. In describing the present invention, identical or corresponding elements will be given the same reference numerals, regardless of the figure number, for helping entirely understand the present invention.

### DESCRIPTION OF DRAWINGS

Since the following drawings attached to the specification is for illustrating embodiments according to the present invention and for understanding the technical concept of the present invention together with the following detailed description, the present invention should not be interpreted by the matters showing on the drawings.

FIG. 1 shows a basic mechanism of S&W (Stop-and-Wait) ARQ;

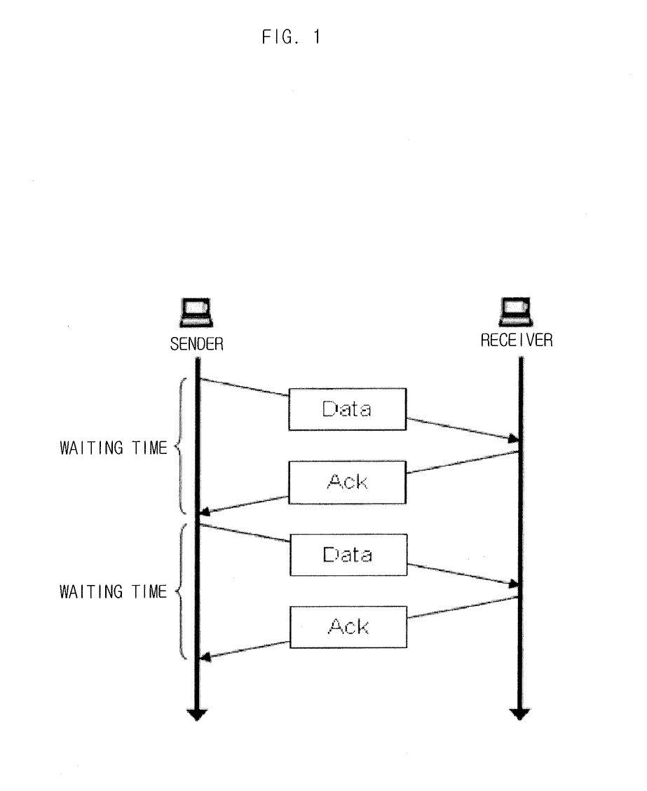

FIG. 2 shows an ACK mechanism in Normal ARQ;

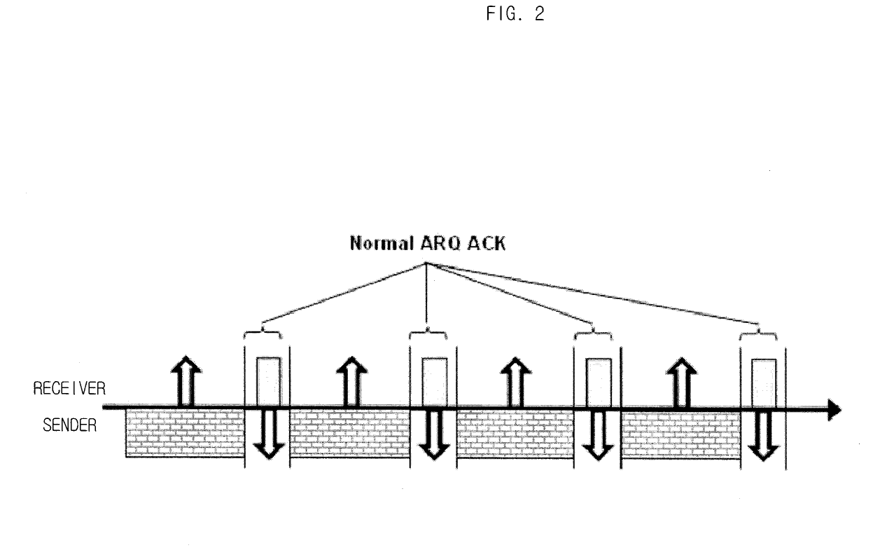

FIG. 3 shows a basic procedure of a BA mechanism based on IEEE 802.11e;

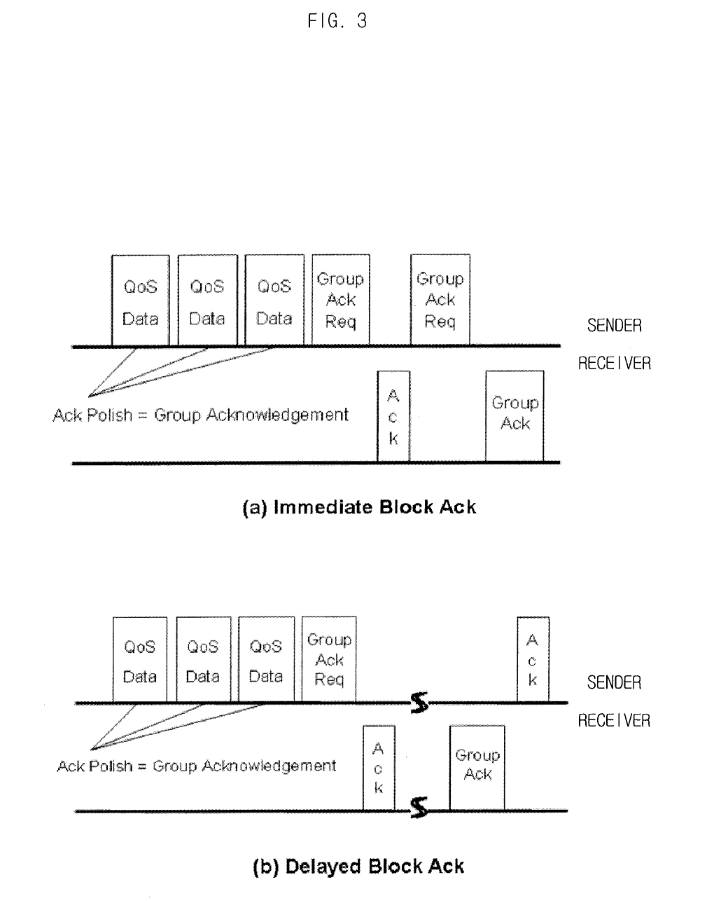

FIG. 4 shows the basic frame configuration of an enhanced BA based on IEEE 802.11n;

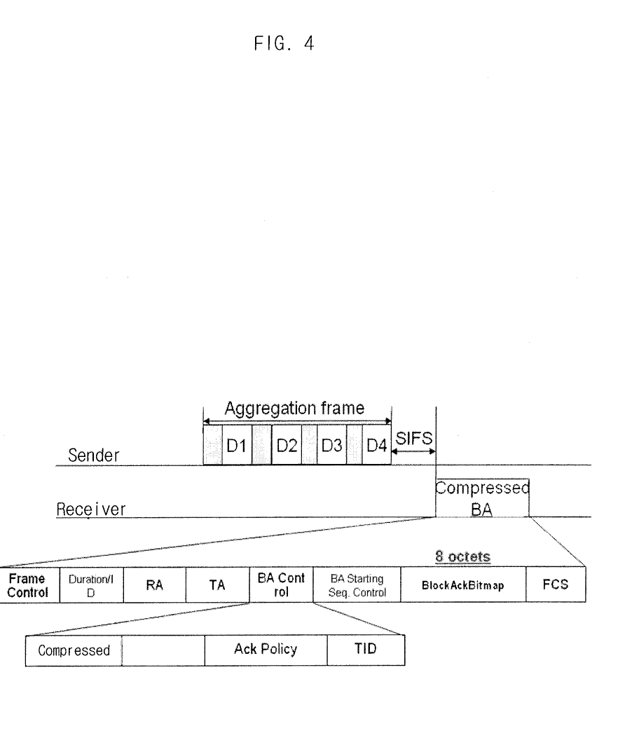

FIG. 5 illustrates a Block ACK mechanism based on the IEEE 802.11e standard;

FIG. 6 shows a Pervasive_Block_ACK (PBA) mechanism in accordance with an embodiment of the present invention;

FIG. 7 is a sequence of the Pervasive_Block_Ack mechanism in accordance with an embodiment of the present invention;

FIG. 8 shows a data frame format of the PBA mechanism in accordance with an embodiment of the present invention;

FIG. 9 shows an ACK frame format of the PBA mechanism in accordance with an embodiment of present invention;

FIG. 10 shows a data transmission procedure of the sender side in accordance with an embodiment of the present invention;

FIG. 11 shows a data processing procedure of the receiver side in accordance with an embodiment of the present invention;

FIG. 12 shows data retransmission by the sender side in accordance with an embodiment of the present invention;

FIG. 13 shows a finishing procedure of receiving data of the receiver side in accordance with an embodiment of the present invention;

FIG. 14 illustrates various frame formats for calculating an analytical formula in accordance with an embodiment of the present invention;

FIG. 15 is a graph of the amount of control traffic caused by the increase in the number of data frames in accordance with an embodiment of the present invention;

FIG. 16 is a graph of the amount of control traffic related to Block ACK included in an ACK set in accordance with an embodiment of the present invention;

FIG. 17 is a graph of total traffic load caused by the increase in the number of data frames in accordance with an embodiment of the present invention;

FIG. 18 is a graph of total traffic load related to the number of Block ACKs included in an ACK set in accordance with an embodiment of the present invention; and

FIG. 19 is a graph showing the change in the number of transmissions of ACK frame and control frames caused by the increase in the number of blocks included in ACK set, in accordance with an embodiment of the present invention.

### MODE FOR INVENTION

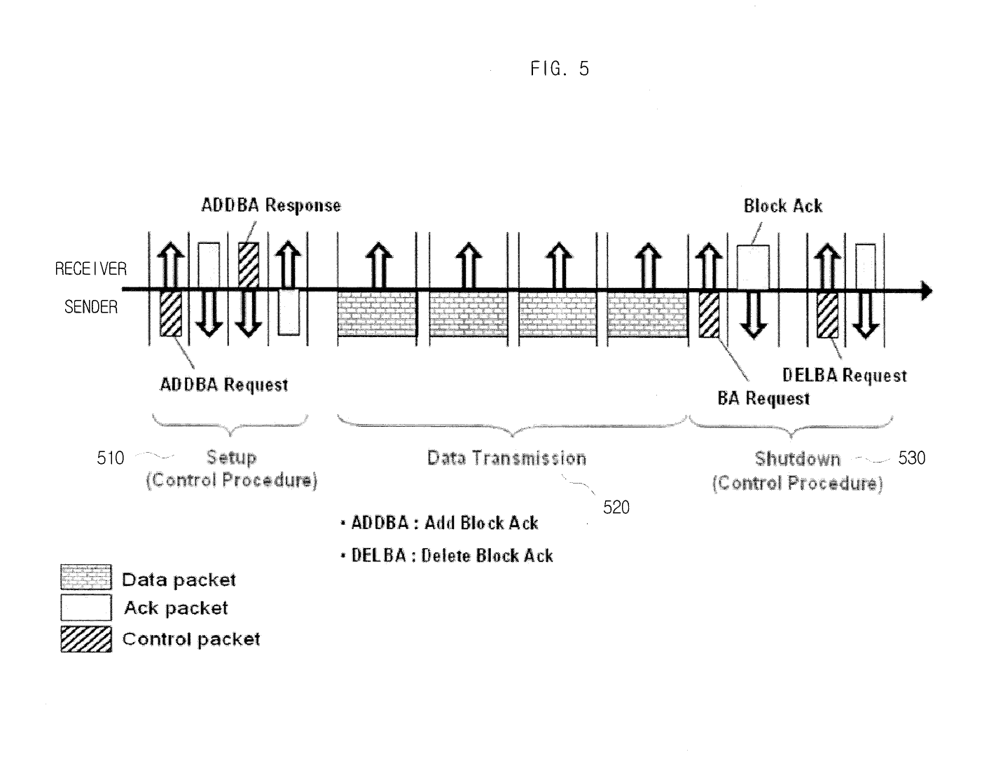

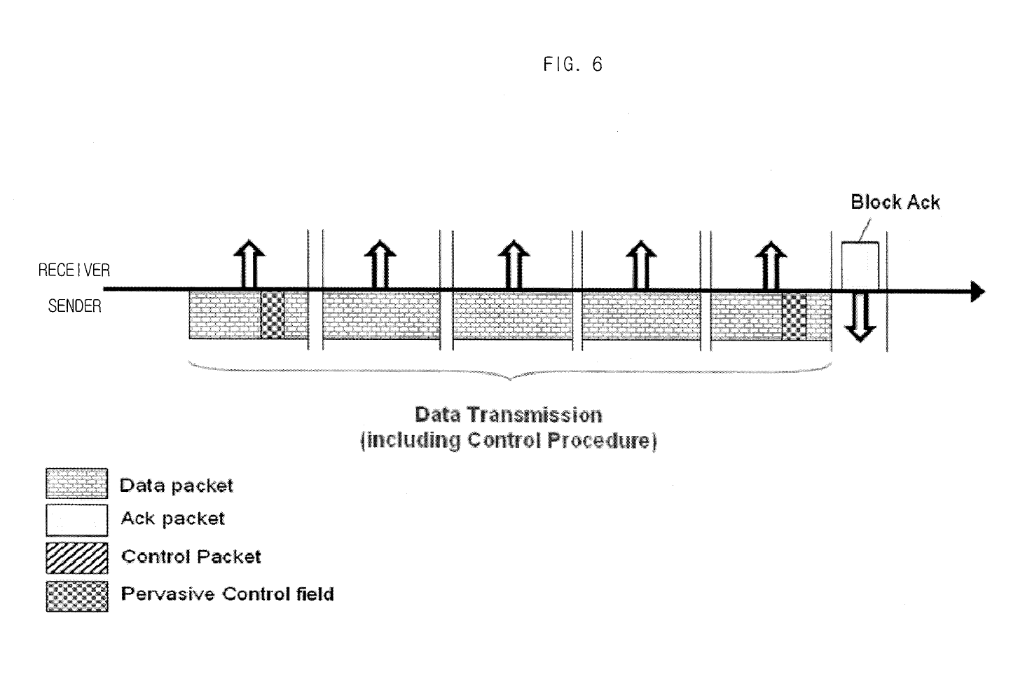

FIG. 5 illustrates the Block ACK (BA) mechanism based on the IEEE 802.11e standard, and FIG. 6 shows the Pervasive_Block_ACK (PBA) mechanism in accordance with an embodiment of the present invention. Hereinafter, features of the present invention will be discussed in comparison with FIG. 5 and FIG. 6.

Referring FIG. 5 first, the BA mechanism can consist of a setup step 510, a data transmission step 520, and a shutdown step 530.

In the setup step 510, a sender who wants to transmit data sends an ADDBA (Add Block Ack) request to a receiver. An ADDBA request frame comprises an identifier of the ADDBA request frame, a dialog token field, a BA parameter set field, and a BA timeout value.

On receiving the ADDBA request, the sender transmits ADDBA response. The ADDBA response frame comprises an identifier of the ADDBA response frame, a dialog token obtained from the ADDBA request frame, a BA parameter set field, and a BA timeout value.

After finishing the ADDBA request and ADDBA response, the data transmission step 520 will begin. In the data transmission step 520, the sender transmits a plurality of data frames to the receiver.

After finishing the data transmission step 520, the shutdown step 530 will begin. At this time, the sender transmits the BA request to the receiver, and the receiver sends the BA response on receiving the BA request. On receiving the BA response, the sender transmits a DELBA (Delete Block Ack) request. A DELBA request frame comprises an identifier of the DELBA request frame and DELBA parameter field.

As described above, the BA mechanism may have an overload being caused by control packets, and thus it is not preferable in a wireless environment requiring maximum efficiency (e.g., underwater wireless telecommunication).

On the contrary, the PBA mechanism according to the present invention can increase the efficiency of a whole network by reducing the frequency in traffic generation to be suitable to the extremely-poor wireless environment (e.g., underwater wireless telecommunication).

Referring to FIG. 6, the PBA mechanism according to the present invention abbreviates initiation and shutdown procedures by inserting an Initiation field and a Block ACK request field into some portion of the transmission data frames such that the generation of overhead can be reduced. Therefore, if the sender transmits wireless data by use of the PBA mechanism, the traffic generation frequency can be reduced in comparison with the case of using the BA mechanism in FIG. 5.

Especially, because the PBA mechanism can be applied to an extremely-poor wireless environment (e.g., underwater), it can be more useful, and if the wireless telecommunication is performed under water, the wireless telecommunication can be performed by use of the sound wave. For example, the need to reduce the number of messages increases as compared with the ground communication because the message LQI (Link Quality Indication) ability considerably drops under water. Assuming that end nodes use an application for measuring water temperatures or salinity to periodically transmit to a sink node, if the period of node at the main point is reduced to ⅓, the number of data transmission will increase by three times and the queue at the main node will be full of data to be transmitted. Also, when the end node is configured to transmit a still image in a JPG file when detecting a certain big change (e.g., speed of current), even if the size of the file is 100 Kbytes at the most, the file will be transmitted in as many successive packets through fragmentation. If wireless data is transmitted by the PBA mechanism in the aforementioned example, the frequency of traffic generation is reduced such that the efficiency of the whole network will increase. However, as the aforementioned example is just one of the applications according to the present invention, it is apparent that the present invention is not limited to the aforementioned example.

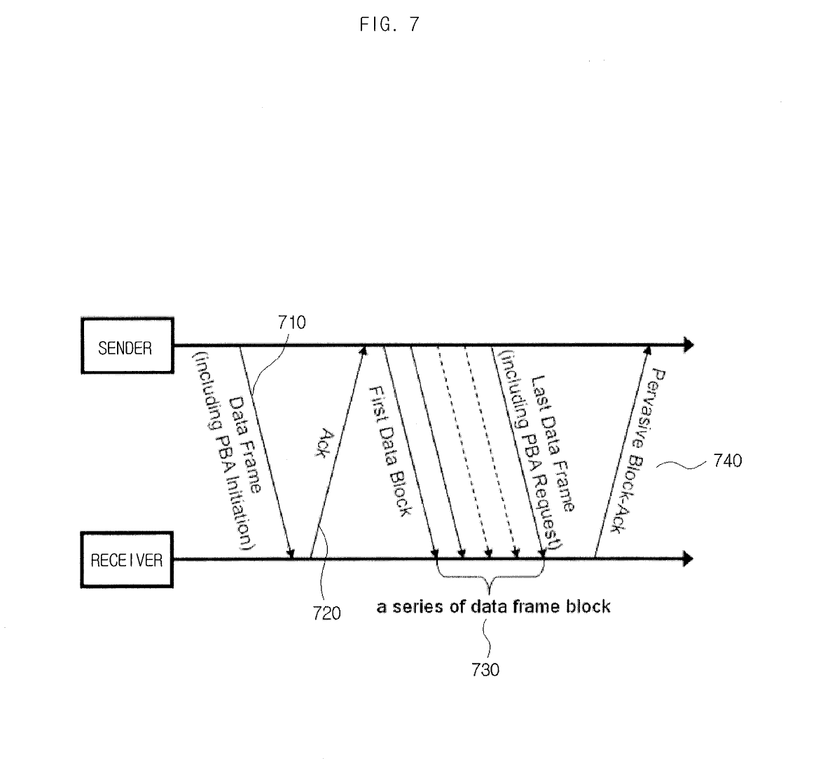

Also, the PBA mechanism according to the present invention can be applied to various topologies. For example, assuming that the sink node and plural end nodes communicate with each other in the infrastructure topology, it can be useful for one end node to transmit a large quantity of data to the sink node, and it can be applied to the error control of all link-by-link connections including an ad-hoc network as well as the infrastructure topology. Although it was impossible to detect and recover an error in an initial ALOHA and slotted ALOHA, the application is now possible regardless the configurations of topology such as star, tree, mash, cluster tree, etc. Hereinafter, the basic flow of the PBA mechanism will be described with reference to FIG. 7.

FIG. 7 is a sequence showing the Pervasive_Block_Ack mechanism according to an embodiment of the present invention.

As described above, unlike other mechanisms (e.g., S&W ARQ, BA based on IEEE 802.11e), the PBA mechanism according to the present invention keeps overhead to a minimum through abbreviating the initiation and shutdown procedures and including the initial and shutdown procedures in some portion of data frames.

Referring to FIG. 7, as the sender transmits data frames stored in its queue, at step 710, during the transmission of data frames without initiation procedure, the sender transmits the data frame including a field for PBA initiation as an indicator that the next packet is an object of the PBA. The field for PBA initiation comprises a flag field and a state field, and these fields will be described below. In addition, as the data frame including these fields plays an important role in initiation, the conventional ARQ mechanism is used for transmission to secure the reliability from the side of the sender.

When the sender receives ACK as a response for the data frame including PBA initiation data at step 720, step 730 is performed such that a plurality of data frames are successively transmitted by use of the PBA mechanism, and the data frames transmitted by this way are stored in the queue of the receiver. At this time, to abbreviate additional shutdown steps caused by the end of data transmission, the sender includes a field (Block ACK requesting field) indicating a message requesting PBA in the last data frame to be transmitted.

In step 740, the receiver checks the data frames stored in its queue and transmits an accumulative response by one of PBA and PB-NAK (Pervasive Block NAK). The sender retransmits data frames that failed in transmission based on the response message. Of course, if there is no data frame failed in transmission, the retransmission will be omitted, and the retransmission procedure will be described below.

Hereinafter, before describing the data transmission procedure on the sender side and data processing steps on the receiver side according to the an embodiment of the present invention, a data frame 800 and an ACK frame of the PBA mechanism for describing the above two steps will be described first.

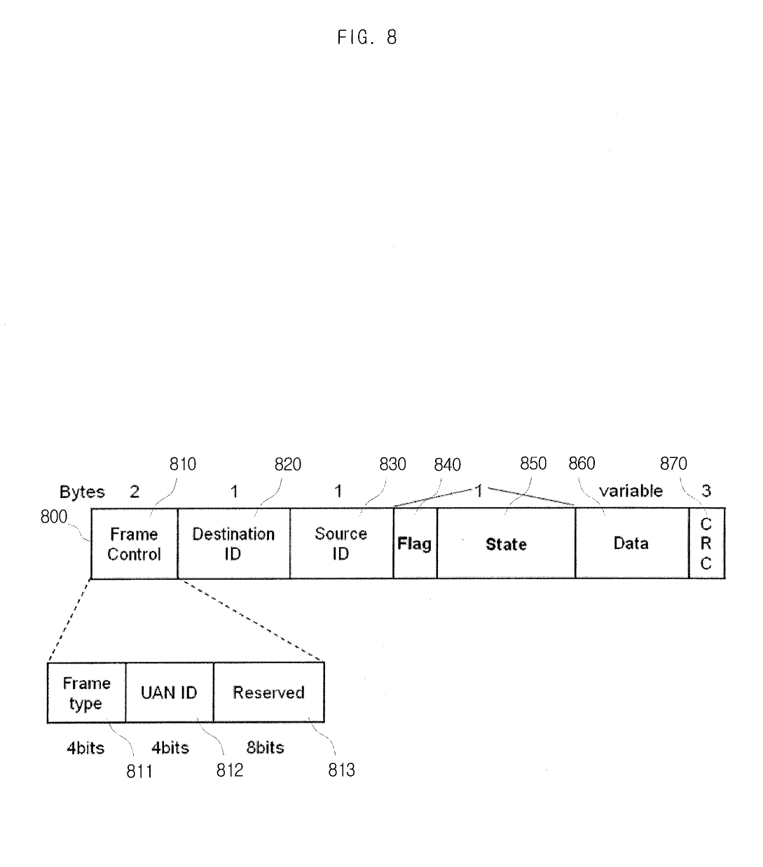

FIG. 8 shows a data frame format of the PBA mechanism according to an embodiment of the present invention.

Referring to FIG. 8, the data frame 800 comprises a frame control field 810 consisting of a frame type field 811 indicating the type of frame being transmitted, an UAN ID field 812 indicating the ID of a network where the node is located and reserved a field 813 indicating a reserved space for being added later, a destination ID field 820 indicating the ID of a destination node, a source ID field 830 indicating the ID of a transmitting node, a flag field 840 indicating the start and end of a PBA mechanism operation, a state field 850 indicating the number of data remained to be transmitted in one set by PBA, a data field 860 comprising data to be transmitted by PBA, and a CRC field 870 for frame security.

One byte can be assigned to the flag field 840 and the state field 850, and the size of data assigned to each field can vary. For example, 1 bit may be assigned to the flag field 840, and 7 bits may be assigned to the state field 850. Also, the length of data field 860 can vary.

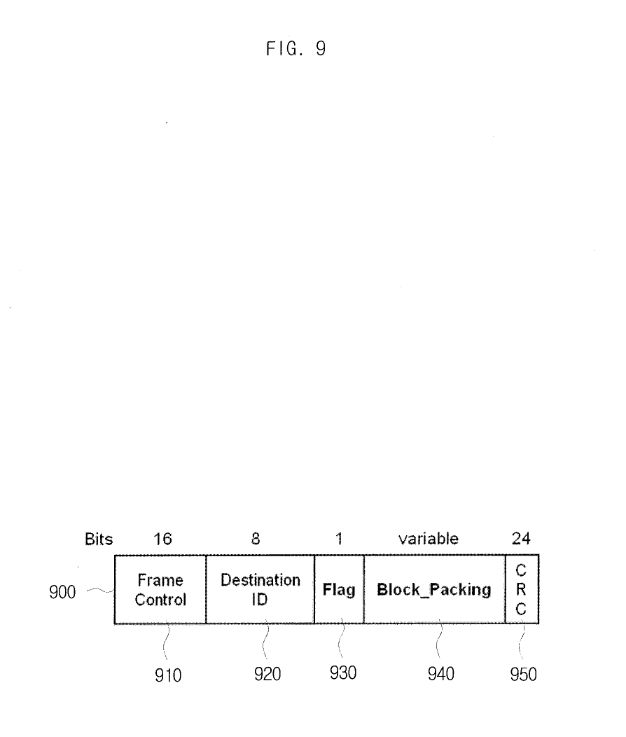

FIG. 9 shows an ACK frame format of the PBA mechanism according to an embodiment of present invention.

Referring to FIG. 9, an ACK frame 900 comprises a frame control field 910 consisting of a frame type field (not shown) indicating the type of frame being transmitted, an UAN ID field (not shown) indicating the ID of a network where the node is located and a reserved field (not shown) indicating a reserved space for being added later, a destination ID field 920 indicating the ID of a destination node, a flag field 930 indicating PBA or PB-NAK based on the number of complete data frame blocks, a block packing field 940 indicating whether retransmission of frames is required or not, and a CRC field 950 for frame security.

Sixteen bits can be assigned to the frame control field 910. The length of each field in the frame control field 910 may vary. For example, 4 bits may be assigned to the frame type field, 4 bits to the UAN ID field, and 8 bits to the reserved field. Also, the length or size of the block packing field 940 can vary.

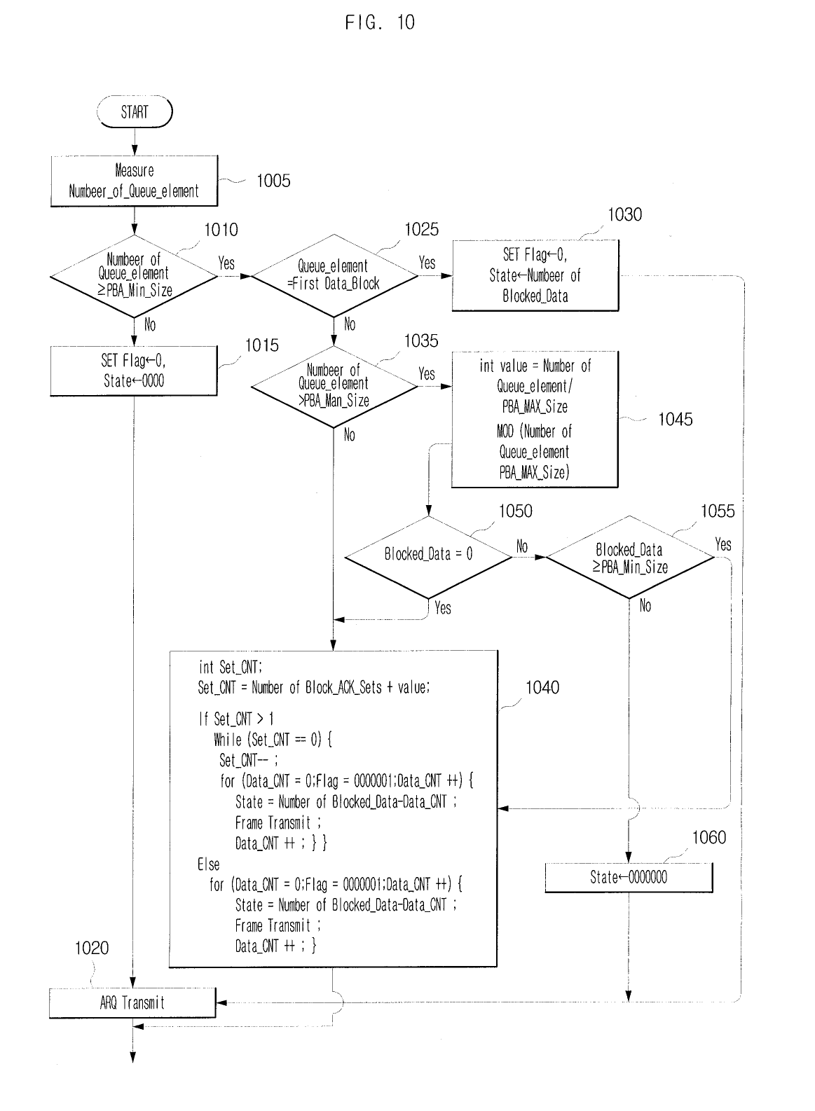

FIG. 10 shows a data transmission procedure on the sender side according to an embodiment of the present invention.

Variables and values of field being used for describing the data transmission procedure on the sender side are defined in TABLE 1 and TABLE 2.

TABLE 1
Variables and description

| Variable | Description |
|---|---|
| Queue_element | Data Frame(s) in Queue at the sender side |
| Set_CNT | Variable for counting Block_ACK_Sets |
| Data_CNT | Variable for numbering Data_Blocks in one |
| | Block_ACK_Set |
| PBA_Max_Size | Maximum number of frames included in one |
| | Block_ACK_Set for sending PBA |
| PBA_Min_Size | Minimum number of frames included in one |
| | Block_ACK_Set for sending PBA |
| Blocked_data | Remaining data as a result of dividing |
| | Queue_elements into several Block_ACK_Sets |
| Block_ACK_Set | Block_ACK set transmitted through BBA |
| | at a time |
| Data_Block | Each frame in current Block_ACK_Set |

TABLE 2
Values of PBA state field and description

| Block_ACK | | |
|---|---|---|
| State field value | | |
| Flag | State | Description |
| 0 | 0000000 | Sending by conventional ARQ, not Block_ACK |
| 1 | xxxxxxx | Data frame including Block_ACK Initiation |
| 0 | xxxxxxx | Data frame being Transmitted through Block_ACK |
| 0 | 0000001 | Last frame including Block_ACK Request |

In step 1005, whenever the sender side obtains a chance of transmission through various mechanism such as Polling, the sender counts the number of Queue_elements (data frames) to measure how much data is accumulated in its queue. In this case, the measuring cycle can vary according to the type of traffic or the network load.

In step 1010, if the number of Queue_elements is smaller than PBA_Min_Size after comparing the number (or size) of Queue_elements (data frames stored in queue) to PBA_Min_Size (predetermined minimum size), step 1015 is performed.

In step 1015, as defined in Table 2, the flag field 840 is set to 0 and the state filed 850 is set to 0000000. However, it is preferable for the flag field 840 and the state filed 850 to have 0 and 0000000, respectively, by default.

In step 1020, the sender transmits to the receiver data stored in its queue by use of the ARQ mechanism.

In step 1010, if the number of Queue_elements is equal to or greater than PBA_Min_Size after comparing the number of Queue_elements to PBA_Min_Size, the sender proceeds to step 1025.

In step 1025, if Queue_element is determined as the first data frame (First Data_Block), step 1030 is performed.

In step 1030, the sender sets 1 in the flag field 840 and the number of blocked data (remaining data) in the state filed 850, then proceeds to step 1020 to transmit the data frame by use of the ARQ mechanism. Here, 1, which is set in the flag field 840, is an identification of the first data frame and works for initiation. The meaning of each field value is defined in Table 2. It is preferable for the flag field 840 and the state field 850 to have 0 and 0000000, respectively, by default. As described above, as the data frame including these fields works for initiation, the data frame is transmitted by use of the conventional ARQ mechanism to secure reliability from the receiver side.

In step 1025, if Queue_element is not the first data frame (First Data_Block), step 1035 is performed.

In step 1035, if the number of Queue_elements is determined to be smaller than PBA_Max_Size after comparing the number (or size) of Queue_elements to PBA_Max_Size (predetermined maximum size), step 1040 is performed.

In step 1040, the sender transmits the data frames successively according to the content of the program. If the data frame being transmitted is the last data frame, the Block ACK request field is included. The Block ACK request field can comprise the flag field 840 and the state field 850, and in case the flag field 840 is set to 0 and the state field 850 is set to 0000001, the data frame being transmitted can be recognized as the list data frame including Block ACK request field. The last data frame means a data frame to be finally transmitted among data frames being successively transmitted, and works for requesting PBA (Pervasive_Block_ACK).

In step 1035, if the number of Queue_elements is equal to or greater than PBA_Max_Size after comparing the number of Queue_elements to PBA_Max_Size, the sender proceeds to step 1045.

In step 1045, the sender uses a predetermined function (e.g., MOD function) to divide the data frames into a number of Block_ACK_Sets of PBA_Max_Size, and then step 1050 is performed.

In step 1050, if Blocked_data (remaining data) is determined to be 0, the sender proceeds to step 1040 to transmit the data frame as described above; if Blocked_data (remaining data) is not 0, the sender proceeds to step 1055.

In step 1055, if Blocked_data is smaller than PBA_Min_Size after comparing Blocked_data to PBA_Min_Size, the sender proceeds to step 1060. In step 1060, after setting the state field 850 to 0000000, the sender transmits the data frame by use of the ARQ mechanism.

In step 1055, if Blocked_data is equal to or greater than PBA_Min_Size after comparing Blocked_data to PBA_Min_Size, the sender proceeds to step 1040 to transmit the data frame as described above.

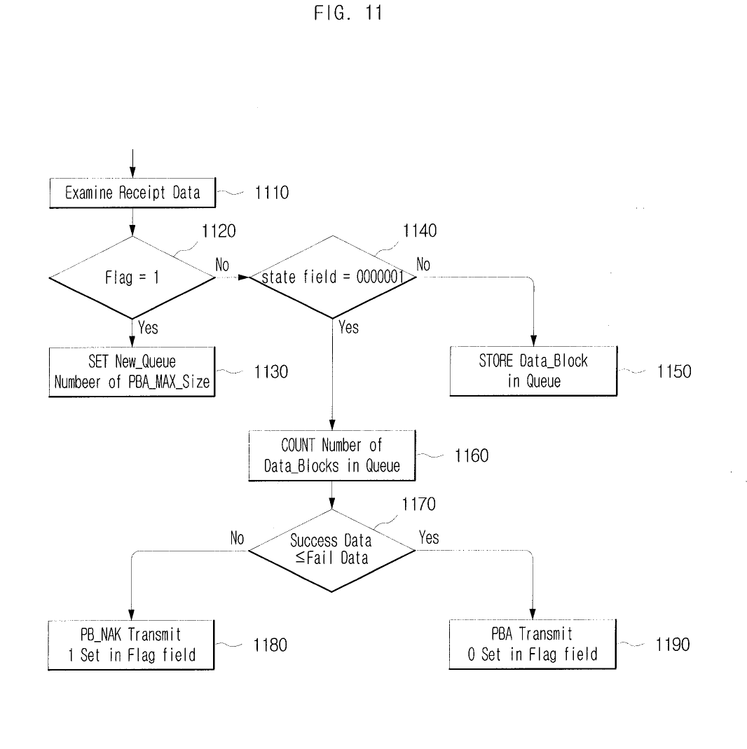

FIG. 11 shows a data processing procedure on the receiver side according to an embodiment of the present invention.

Referring to FIG. 11, in step 1110, the receiver receives a data frame from the sender.

In step 1120, if the received data frame is determined to include an Initiation field (e.g., the value of the flag field 840 is 1), the receiver recognizes the start of a new Block ACK set, and then step 1130 is performed. In step 1130, the receiver transmits to the sender ACK corresponding to the receiving of the data frame having the Initiation field, and sets its queue by a predetermined size (e.g., sets New_Queues to correspond to PBA_Max_Size). Also, the receiver recognizes the start of a new Block ACK set and stores the received data frames and each completion or failure in a buffer.

In step 1120, if the value of the flag field 840 of the received data frame is not 1, the receiver proceeds to step 1140.

In step 1140, if the value of the state field 850 of the received data frame is not 0000001, the receiver proceeds to step 1150 to store Data_Block in its queue.

In step 1140, if the value of the state field 850 of the received data frame is determined to be 0000001, the receiver proceeds to step 1160 to count the number of Data_Blocks in the queue and proceeds to step 1170.

In step 1170, if the number of transmission-completed data frames is greater than the number of transmission-failed data frames, the receiver proceeds to step 1180 to set the flag field to 1 and transmits PB-NAK to the sender. There is the Block_Packing field having variable lengths in an ACK frame format to be transmitted to the sender, and the Block_Packing field consists of a sequence number to indicate whether or not retransmission of frames is required.

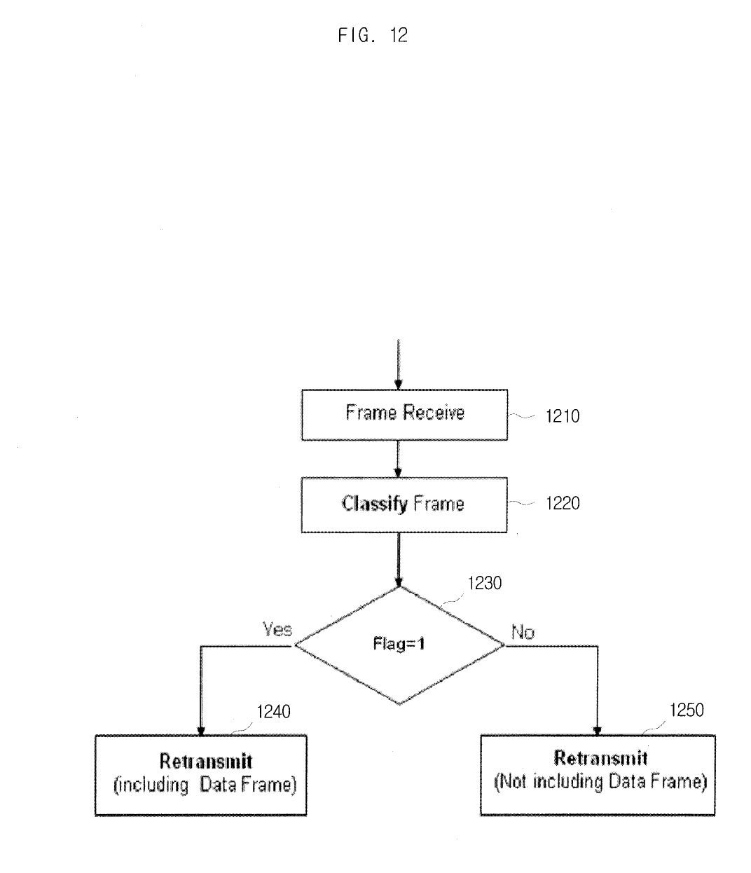

In step 1170, if the number of transmission-failed data frames is greater than the number of transmission-completed data frames, the receiver proceeds to step 1190 to set the flag field 930 to 0 and transmits PBA to the sender. On receiving PB-NAK or PBA, the sender performs a retransmission procedure for failed data frames, and the retransmission procedure of data frame will be described below with reference to FIG. 12.

FIG. 12 shows data retransmission by the sender according to an embodiment of the present invention.

In step 1210, after receiving the ACK frame from the receiver, the sender classifies the received ACK frames in step 1220.

In step 1230, if the value of the flag field 930 of the ACK frame is 0, the sender recognizes it as receiving PBA and proceeds to step 1250. In step 1250, the sender transmits the data frames that are not included in the Block_Packing field 940.

In addition, In step 1230, if the value of the flag field 930 of the ACK frame is 1, the sender recognizes it as receiving PB-NAK and proceeds to step 1240. In step 1240, the sender transmits the data frames that are included in the Block_Packing field 940.

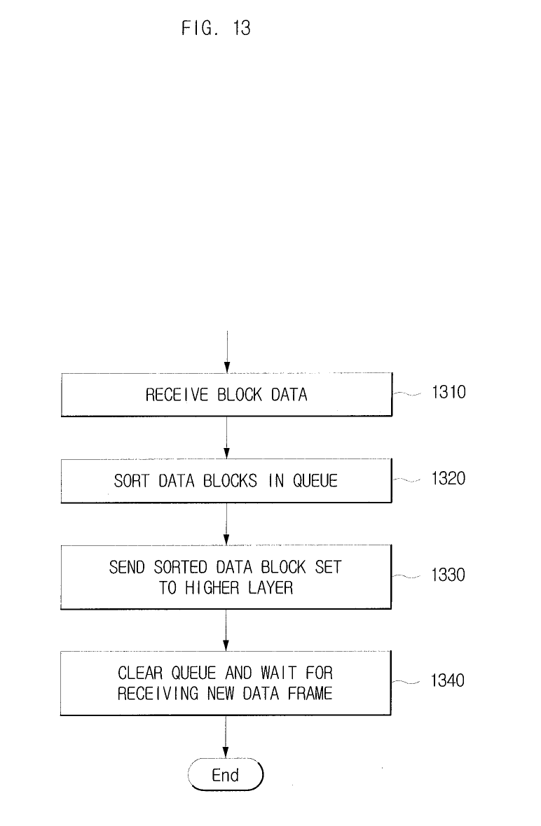

FIG. 13 shows a finishing procedure of receiving data on the receiver since according to an embodiment of the present invention.

In step 1310, the receiver receives the data frame being retransmitted from the sender.

In step 1320, the receiver sequentially synchronizes the retransmitted data frames that has been handled as failed transmission in its queue, and then proceeds to step 1330 to forward the set of finished data frames to a higher layer.

In step 1340, the sender vacates the queue and waits for data frames to be transmitted by use of a new data frame block set or the ARQ mechanism.

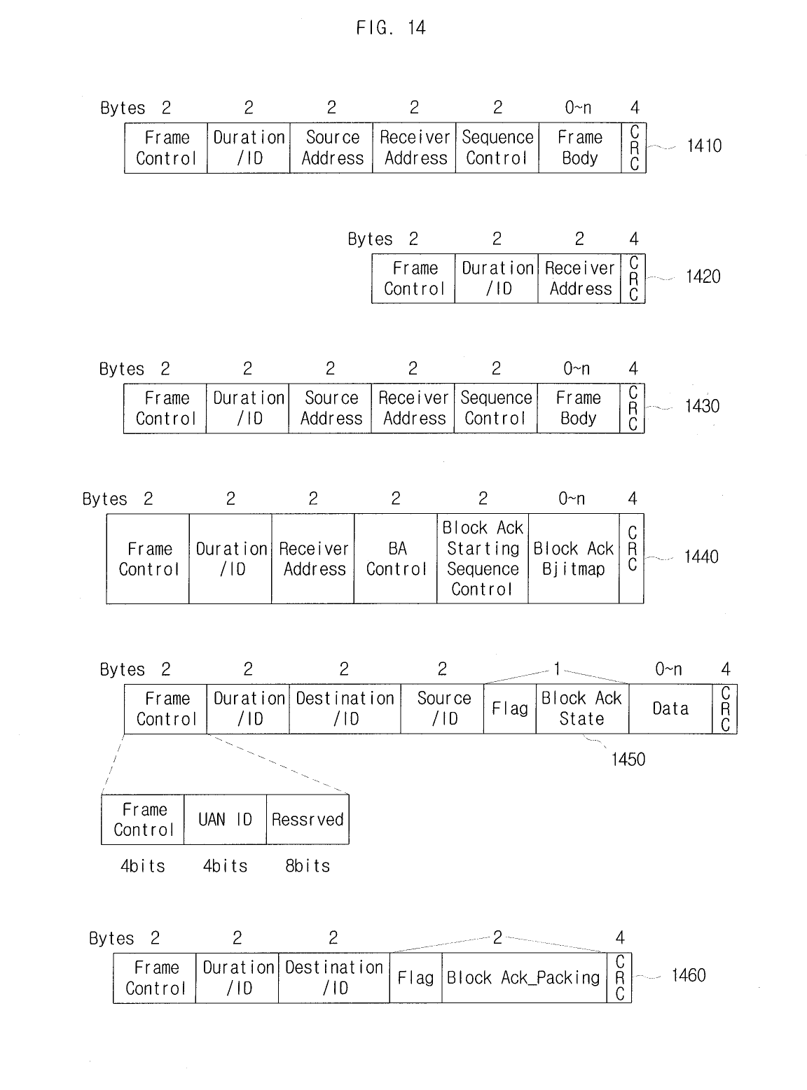

FIG. 14 illustrates various frame formats for calculating analytical formula according to an embodiment of the present invention.

TABLE 3
Definitions of terms for defining Analytical Formula of PBA
Term definition

| Term | Definition |
|---|---|
| C | Maximum network processing rate (Bandwidth) |
| R | Frame transmission rate (Data Rate) |
| B | Number of blocked ACKs |
| data | Data frame including control data |
| SET | Frame indicating start and end of Block ACK |
| ACK | Frame required to transmit one ACK |
| Lₜₒₜₐₗ | Sum of lengths of frames for data transmission |
| | completion (Data frame + ACK frame) |
| L_{data} | Length of data frame including control data |
| L_{payload} | Length of MSDU, i.e., payload |
| L_{control} | Total length of control data for data transmission |
| | completion |
| L_{ack} | Length of ACK frame |
| L_{ack} | Total sum of length of ACK frame occurred at |
| | corresponding link |
| Nₜₒₜₐₗ | Total number of transmission |
| N_{data} | Number of data frame transmission |
| N_{ack} | Number of ACK frame transmission |
| N_{control} | Number of control frame transmissions except ACK |
| | (BA association + de-association) |
| Len( ) | Function of calculating the length of frame |
| int( ) | Integer function (Rounded-up) |

Referring to FIG. 14, referential numeral 1410 is an ARQ frame format of the data frame, referential numeral 1420 an ARQ frame format of the ACK frame, referential numeral 1430 a Block ARQ frame format of the data frame, referential numeral 1440 a Block ARQ frame format of the ACK frame, referential numeral 1450 a PBA frame format of the data frame, and referential numeral 1460 a PBA frame format of the ACK frame.

Although a sensor network that does not require long addresses will be described hereinafter as an example of the working environment of the present invention for easy understanding of the present invention and for simple calculation, the scope of the present invention is not limited to the example. For example, as shown in FIG. 14, it will be assumed that the source address and the destination address are 2 bytes each.

Usability of channel can be expressed as ^{R}/_{C}, which is a frame rate divided by a total bandwidth. The efficiency of a currently-used channel refers to a ratio of the length of data in an entire transmission frame, and can be expressed as

$$\frac{{L}_{payload}}{{L}_{total}} = \frac{{L}_{total} - {L}_{control}}{{L}_{total}}$$

by converting the number of bits used in the frame to a length.

The length of an entire transmission frame is a sum of the length of payload, which is pure data, and the length of the remaining data, which is for control. L_{control}, whish is the length of control data, is a sum of the length of the data frame from which the payload is subtracted and the length for transmitting ACK (Formulas 1 and 2).

Lₜₒₜₐₗ=L_{payload}+L_{control} [Formula 1]

L_{control}=(L_{data}−L_{payload})+L_{ack} [Formula 2]

The lengths of the three types of ACK frames shown in FIG. 14 have a relationship shown in Formula 3 when fields excluding the ACK data are the same. Formula 4 to 6 illustrate configurations of ARQ, Block ACK and PBA, and frame length calculations of each frame shown in FIG. 14.

Len(ACK_{ARQ})<Len(ACK_{PBA})<Len(ACK_{BA}) [Formula 3]

ACK_{ARQ}=Frame Control+Duration ID+Destination ID+CRC [Formula 4]

2+2+2=4=10 bytes=80 bits/Ack_frame

ACK_{BA}=Frame Control+Duration ID+Destination ID+(BA Control+Block Ack Sequence Control+Block Ack Bitmap)+CRC [Formula 5]

2+2+2+(2+2+2)+4=16 bytes=128 bits/Block_{—}Ack_frame

ACK_{PBA}=Frame Control+Duration ID+Destination ID+(Flag+PBA Bitmap)+CRC [Formula 6]

2+2+2+(2)+4=12 bytes=96 bits/Pervasive Block ACK_frame

The lengths of data frames are almost the same in each mechanism in FIG. 14 (Formulas 7 to 9). This means that the efficiency of channel is determined by the ACK mechanism such as the length of ACK frame and the number of transmission and the difference in the frame lengths rather than the length of data frame when transmitting the same data. data.ARQ, data.BA, and data.PBA in Formulae below mean data frames for ARQ, BA, and PBA, respectively.

L_{data.ARQ}=L_{data.BA}≧L_{data.PBA} [Formula 7]

data·ARQ=data·BA=Frame Control+Duration ID+Source ID+Destination ID+Sequence Control+Payload+CRC [Formula 8]

2+2+2+2+2+Payload+4=14+Payload bytes

data·PBA=Frame Control+Duration ID+Source ID+Destination ID+(Flag+PBA State)+Payload+CRC [Formula 9]

2+2+2+2+(1)+Payload+4=13+Payload bytes

The following illustrates the number of transmissions of ACK frames and control frames, and the total lengths of each message calculated therefrom. Formulas 10 and 11 relate to the ARQ mechanism, Formulas 12 and 13 relate to Block ACK, and Formulas 14 and 15 relate to PBA.

N_{ack.ARQ}=N_{data} [Formula 10]

ΣL_{ack.ARQ}=Len(ACK_{ARQ})×N_{ack.ARQ} [Formula 11]

$$\frac{{N}_{data}}{B}$$

is the number of transmission of data divided by B, the number of Block ACK, and is for calculation of the number of transmission of Block ACK or PBA. The number of transmission of (Pervasive) Block ACK can be integerized by into. The reason why Formula 12 requires the number of transmission three times as much is because SETBA, namely, two frames for BA start and BA end, is added when transmitting Block ACK.

$$\begin{matrix}{N}_{ack \cdot BA} = 3 \cdot int ( \frac{{N}_{data}}{B} ) & [ Formula 12 ] \\ \sum {L}_{ack \cdot BA} = Len ( {ACK}_{BA} ) \times int ( \frac{{N}_{data}}{B} ) + 2 \cdot Len ( {SET}_{BA} ) \cdot int ( \frac{{N}_{data}}{B} ) & [ Formula 13 ]\end{matrix}$$

As compared to BA, there is no transmission of additional control frame for ACK such as SETBA in PBA. It becomes possible to improve the efficiency with minimum information included in ACK and data.

$$\begin{matrix}{N}_{ack \cdot PBA} = int ( \frac{{N}_{data}}{B} ) & [ Formula 14 ] \\ \sum {L}_{ack \cdot PBA} = Len ( {ACK}_{PBA} ) \times int ( \frac{{N}_{data}}{B} ) & [ Formula 15 ]\end{matrix}$$

Hereinafter, the number of transmissions of control frames and total network frames and the length of frames will be analyzed based on the formulae derived above, and it will be proven that the efficiency can be improved with an increase of links.

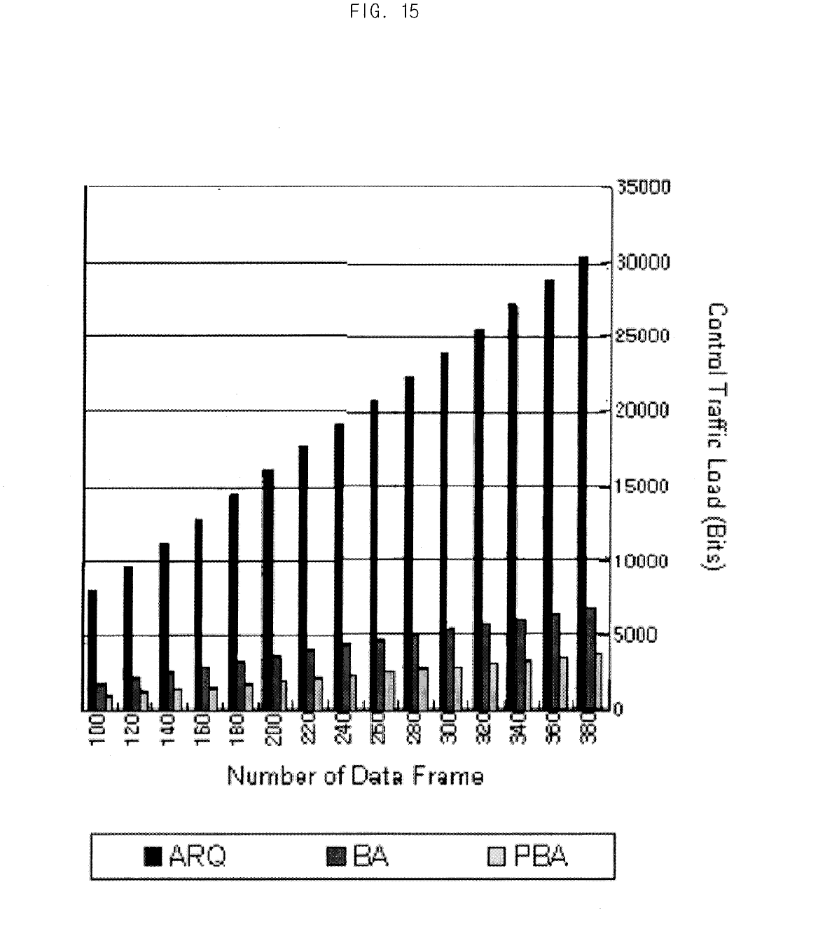

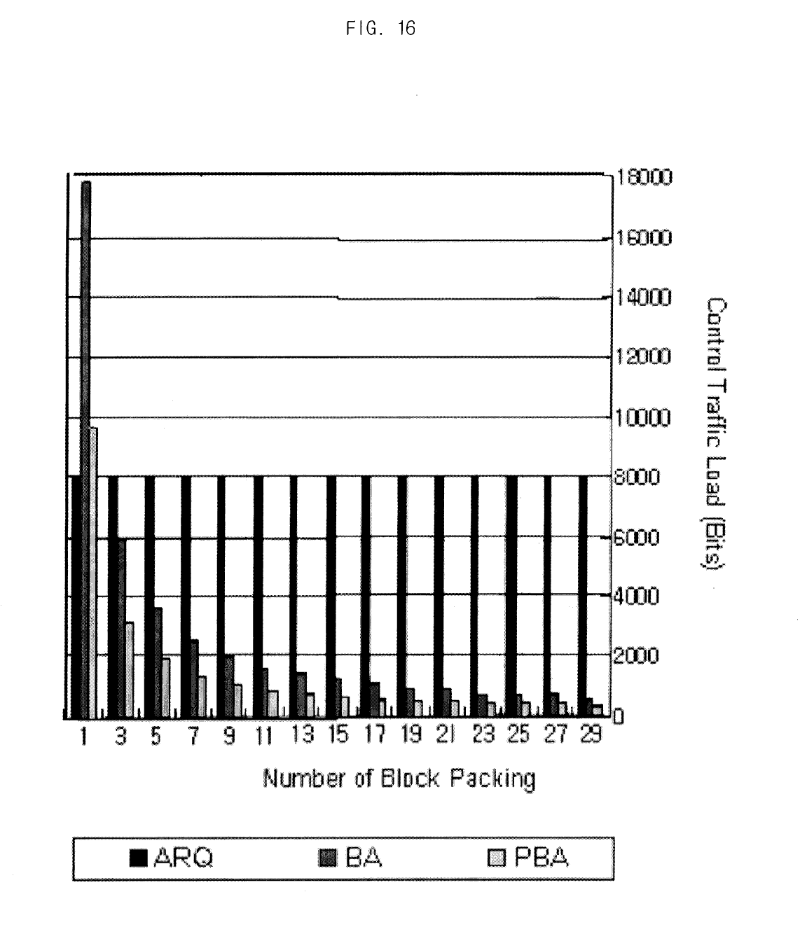

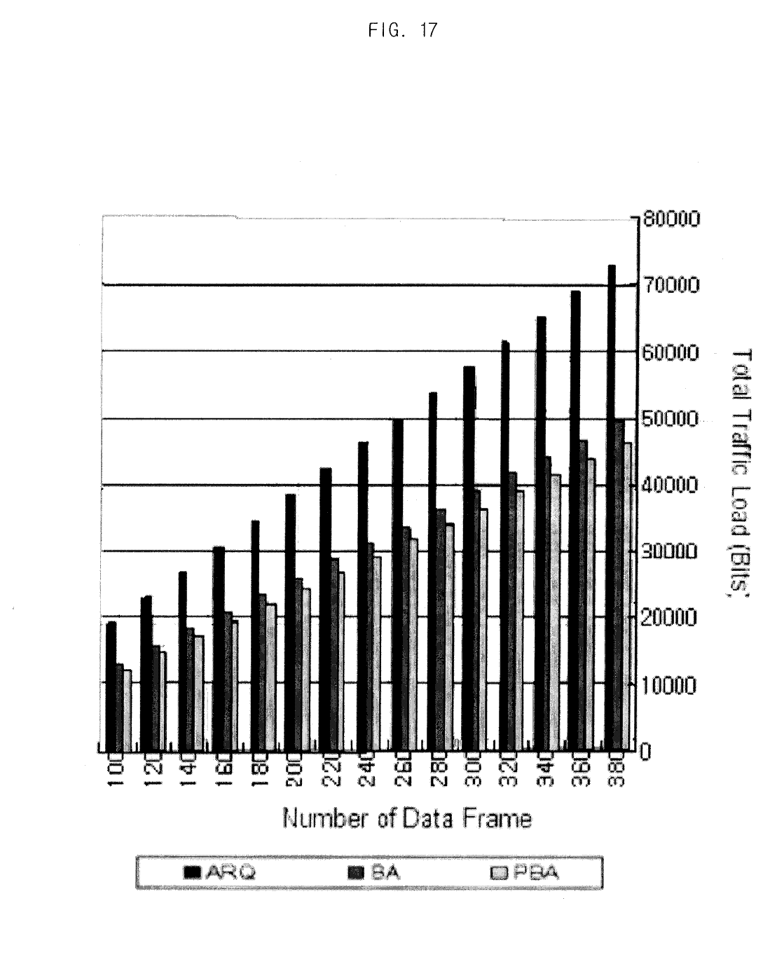

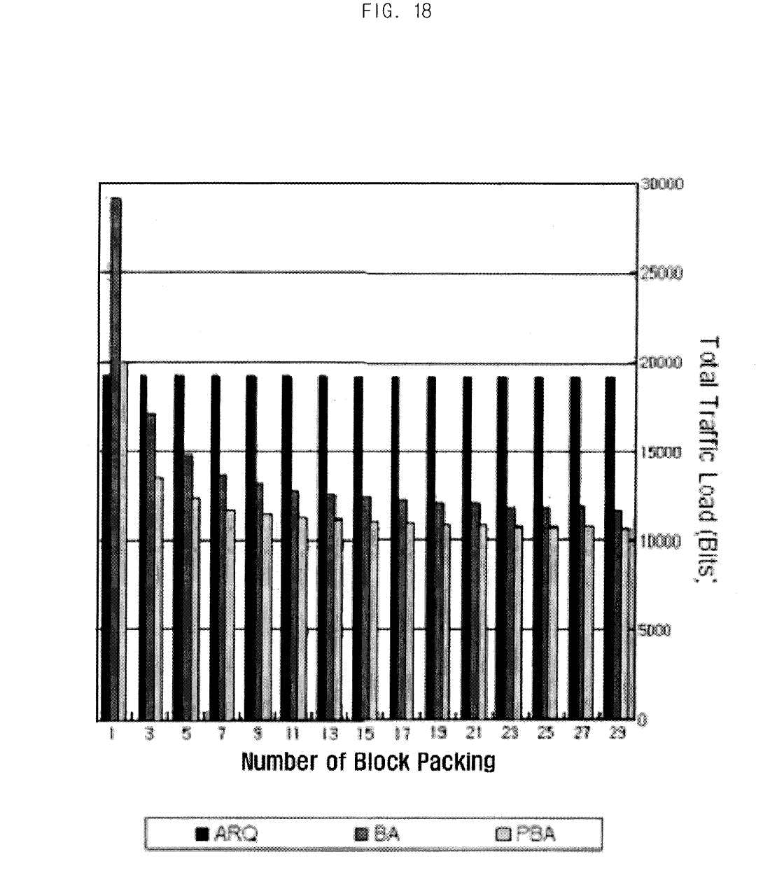

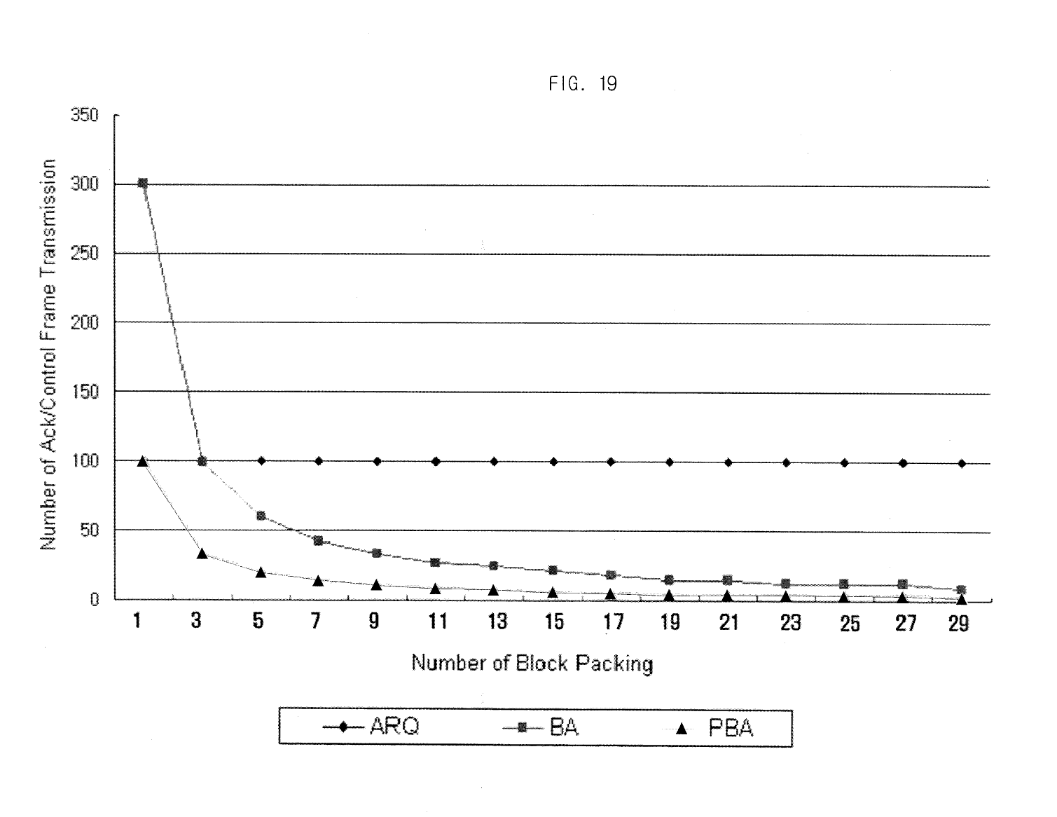

FIG. 15 is a graph of the amount of control traffic caused by the increase in the number of data frames according to an embodiment of the present invention; FIG. 16 is a graph of the amount of control traffic related to Block ACK included in an ACK set according to an embodiment of the present invention; FIG. 17 is a graph of the total traffic load caused by the increase in the number of data frames according to an embodiment of the present invention; FIG. 18 is a graph of the total traffic load related to the number of Block ACKs included in the ACK set according to an embodiment of the present invention; and FIG. 19 is a graph showing the change in the number of transmissions of the ACK frame and control frame caused by the increase in the number of blocks included in the ACK set.

Hereinafter, it will be assumed that the fixed number of blocks is ten, the fixed number of data frames is 100 to plot the graphs according to the above-defined formulae, for example, but those who skilled in the art should understand that these are just one embodiment of the present invention.

Referring to FIG. 15, the control frame load in ARQ related to the increase in the number of data frame on the x-axis increases sharply in proportion to the number of data frames. On the other hand, the increasing range in BA or PBA tends to drop. Especially, PBA, which has a small amount of control frames in itself, shows a small increase in load as compared to Block ACK,

Referring to FIG. 16, the load of control traffic may decrease along with the increase in the number of Block ACK included in one ACK set (i.e., the number of ACKs is decreased by including more ACKs in Block ACK). As ARQ does not support a blocking function, uniform values are shown.

Referring to FIG. 17, all of ARQ, BA and PBA tend to increase along with the increase in the number of transmitted data frames. However, the range of increase is considerably different.

As shown in FIG. 18, along with the increase in the number of Block ACKs included in one ACK set, the range of load increase in transmitted traffic generally tends to decrease. In case of one-to-one telecommunication, Block ACK has a relatively large load due to control frames indicating initiation and shutdown, but along with the increase in the number of ACK included in one ACK Block set, the total traffic load tends to decrease sharply. Similarly, although the load in PBA is a little more than ARQ when performing one-to-one telecommunication because PBA uses ACK frame that is about 2 bytes longer than one used in ARQ, but along with the increase in the number of blocks included in ACK set, the load of PBA tends to decrease more sharply than Block ACK. As blocking is not applied to ARQ, uniform values are shown.

Referring to FIG. 19, as the blocking is not applied to ARQ, there is no change in the number of transmission regardless how many blocks group ACK frames and control frames. However, as Block ACK has more control frames than PBA, there are a greater number of transmissions at first, but along with the increase in the number of blocks, the number of transmissions tends to decrease generally. Compared to this, as PBA has no specific control frame, there are a number of transmissions that are the same as ARQ at first, but along with the increase in the number of blocks, the number of transmissions tends to decrease more sharply than Block ACK.

The method of transmitting and processing data according to the present invention as described above can be embodied in the form of codes and stored in a computer-readable recorded medium that computer. The computer-readable recorded medium includes all kinds of recorded devices, storing data that a computer system can read. The Computer-readable medium includes, for example, a ROM, RAM, CD-ROM, magnetic tape, floppy disc, optical data storage device, etc., and can be embodied in the form of carrier wave such as transmission via the Internet. In addition, the computer-readable recorded medium may store codes that can be distributed to a computer system connected through a network and can be read by a computer through a distribution method.

The above described embodiment of the present invention is disclosed for the purpose of illustration, and those who skilled in the art can make various modifications, changes, and additions within the mete and scope of the present invention, and this modifications, changes, and additions should be interpreted to be included in the claims undermentioned.

### INDUSTRIAL APPLICABILITY

As described above, the method of transmitting wireless data and the recorded medium thereof according to the present invention can improve the completion rate of data transmission under an extremely-poor wireless environment.

Moreover, the method of transmitting wireless data and the recorded medium thereof can improve the efficiency of a network by reducing the number of data transmissions.

Furthermore, the method of transmitting wireless data and the recorded medium thereof can reduce power consumption along with the improvement of network efficiency.

1. A method of transmitting data by a sender coupled to a receiver through a network, comprising:
transmitting a data frame having an Initiation field to the receiver; and
transmitting a plurality of data frames corresponding to the Initiation field.

2. The method of claim 1 further comprising: receiving from the receiver an ACK corresponding to the transmission of the data frame having the Initiation field,
whereas the plurality of data frames are transmitted to the receiver if the ACK is received.

3. The method of claim 1, wherein one of the plurality of data frames comprises a block ACK request field.

4. The method of claim 3, wherein the Initiation field and block ACK request field comprise a flag field and a state field.

5. The method of claim 3 further comprising receiving a Block ACK from the receiver, whereas the Block ACK comprises a Block Packing field.

6. The method of claim 5 further comprising:
determining whether the received Block ACK is a PBA or a PB-NAK; and
transmitting a data frame that is not included in the Block Packing field, if the received Block ACK is a PBA.

7. The method of claim 6 further comprising transmitting a data frame that is included in the Block Packing field, if the received Block ACK is a PB-NAK.

8. The method of claim 1 further comprising determining during data frame transmission whether or not the data frame stored in the sender is larger than a predetermined minimum size, whereas the transmitting the data frame having the Initiation field is performed when the data frame size is larger than the predetermined minimum size.

9. The method of claim 1 further comprising dividing the data frame by use of a predetermined function if the data frame stored in the sender is larger than a predetermined maximum size.

10. A method of processing data by a receiver coupled to a sender through a network, comprising:
receiving a data frame having an Initiation field from the sender; and
receiving from the sender and storing a plurality of data frames corresponding to the Initiation field.

11. The method of claim 10 further comprising storing information on whether or not each of the plurality of data frames is successfully transmitted.

12. The method of claim 10 further comprising setting a queue of the receiver to a size corresponding to the Initiation field.

13. The method of claim 10 further comprising transmitting to the sender an ACK corresponding to the receiving of the data frame having the Initiation field.

14. The method of claim 10 further comprising:
determining whether or not a data frame having a Block ACK request field is received, when receiving the plurality of data frames;
comparing the number of data frames that are successfully transmitted and the number of data frames that failed transmission, among the plurality of received data frames, if the data frame having the Block ACK request field is received; and
transmitting a PBA in the Block ACK to the sender if the number of data frames that failed transmission is equal to or greater than the number of data frames that are successfully transmitted.

15. The method of claim 14 further comprising transmitting a PB-NAK in the Block ACK to the sender if the number of data frames that are successfully transmitted is greater than the number of data frames that failed transmission.

16. The method of claim 15, wherein the Block ACK comprises a flag field and a Block Packing field.

17. The method of claim 15 further comprising:
receiving a data frame transmitted from the sender in accordance with the PBA or PB-NAK transmitted to the sender;
sorting the received data frame in an order by synchronizing with the data frame that failed transmission; and
forwarding the sorted data frame set to a higher layer.

18. A recorded medium tangibly embodying a program of instructions executable by a digital processing device for performing the method of transmitting data of claim 1, the recorded medium being readable by the digital processing device.
